(19) United States
(12) Patent Application Publication
(10) Pub. No.: US 2015/0162051 A1
(43) Pub. Date: Jun. 11, 2015

(54) INDICATION DEVICE FOR HARD DISK DRIVE

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: KANG WU, Shenzhen (CN); BO TIAN, Shenzhen (CN)

(21) Appl. No.: 14/486,330

(22) Filed: Sep. 15, 2014

(30) Foreign Application Priority Data
Dec. 9, 2013 (CN) 2013106573515

(51) Int. Cl. G11B 33/10

(52) U.S. Cl. CPC G11B 33/10

(57) ABSTRACT

An indication device is provided for indicating a working status of a hard disk drive coupling to a backplane. The indication device includes a power supply unit, a control chip, a display unit, and a connector. The connector is coupled to the backplane. The power supply unit powers the control chip and the display unit. The display unit is coupled to the control chip.

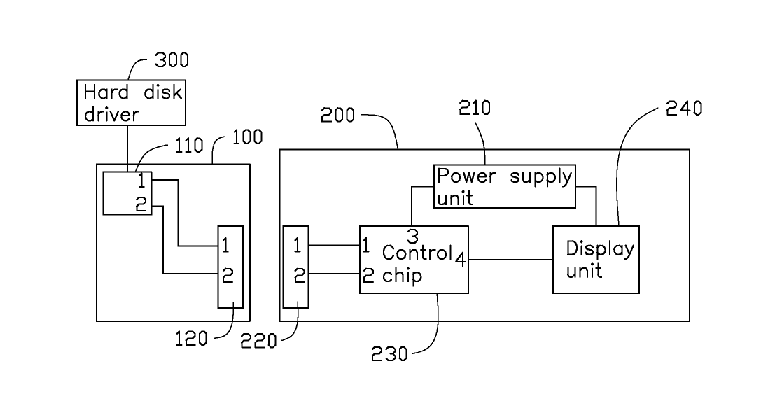

### FIELD

The present disclosure relates to an indication device for indicating a working status of hard disk drives.

### BACKGROUND

Hard disk drives (HDDs) are attached to a backplane having indicators indicating the working status of the HDDs. When the backplane is mounted in a server, some of the indicators may be blocked so that the working status of corresponding HDDs is not easily observed by users.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

The FIGURE is a block diagram of an embodiment of an indication device.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean “at least one.”

The FIGURE illustrates an embodiment of an indication device 200. The indication device 200 is coupled to a backplane 100, which is coupled to a plurality of HDDs 300 and can be used for indicating a working status of the HDDs 300. In the FIGURE, only one HDD 300 is illustrated. In other embodiments, a plurality of HDDs can be used.

The backplane 100 includes first connector 110 and second connector 120 coupled to each other. The first connector 110 is for coupling the HDD 300. The first connector 110 includes a first pin 1 and a second pin 2. The second connector 120 includes a first pin 1 coupled to the first pin 1 of the first connector 110, and a second pin 2 coupled to the second pin 2 of the first connector 110. The first pin 1 of the first connector 110 is capable of detecting the working status of the HDD 300, such as whether the HDD 300 is coupled to the first connector 110. The second pin 2 of the first connector 110 is capable of outputting the working status of the HDD 300.

The indication device 200 includes a power supply unit 210, a third connector 220, a control chip 230, and a display unit 240. The power supply unit 210 powers the control chip 230 and the display unit 240. The control chip 230 is coupled to the third connector 220 and the display unit 240. The second connector 120 includes a first pin 1 capable of coupling to the first pin 1 of the second connector 120, and a second pin 2 of the second connector 120. The control chip 230 includes a first pin 1 capable of coupling to the first pin 1 of the third connector 220, a second pin 2 capable of coupling to the second pin 2 of the third connector 220, a third pin 3 capable of coupling to the power unit 210, and a fourth pin 4 capable of coupling to the display unit 240. The display unit 240 is placed for convenient viewing and displays the working status of the HDD 300.

Even though numerous characteristics and advantages of the embodiment has been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An indication device for indicating a working status of a hard disk drive coupled to a backplane, comprising:
a power supply unit;
a control chip powered by the power supply unit;
a display unit coupled to the control chip and powered by the power supply unit, the display unit displaying the working status of the hard disk drive; and
a connector coupled to the control chip and configured to couple to the backplane.

2. The indication device of claim 1, wherein the connector of the indication unit is coupled to a first connector of the backplane and the first connector of the backplane is coupled to a second connector of the backplane, the second connector of the backplane is coupled to the hard disk drive for transmitting the working status of the hard disk drive.

3. The indication device of claim 1, wherein each of the connectors comprises a first pin and a second pin, the first pins are coupled, the second pins are coupled, the first pin of second connector of the backplane is for detecting whether the hard disk drive is coupled to the backplane, the second pin of the second connector of the backplane transmits the working status to the second pin of the first connector of the backplane.

4. The indication device of claim 1, wherein the control chip comprises a first pin and a second pin coupled to the connector of the indication unit, the control chip comprises a third pin coupled to the power supply unit, and the control chip comprises a fourth pin coupled to the display unit.
